(19) United States
(12) Patent Application Publication
(10) Pub. No.: US 2010/0214883 A1
(43) Pub. Date: Aug. 26, 2010

(54) Oscilloscope Clock

(76) Inventor: Howard Uhler Constantine, IV, Finksburg, MD (US)

Correspondence Address: Howard Constantine IV, 2630 Sandymount Rd., Finksburg, MD, 21048, US

(21) Appl. No.: 12/592,224

(22) Filed: Nov. 20, 2009

Related U.S. Application Data
(60) Provisional application No. 61/203,774, filed on Dec. 29, 2008.

(51) Int. Cl. G04C 17/00

(52) U.S. Cl. 368/239

(57) ABSTRACT

My invention is a new way to use a cathode ray tube, as used in oscilloscopes. My electronic circuit design controls the crt so that a clock face is displayed on the crt's screen, showing the time like a clock. It is meant to be a novelty item, and it is built inside a clear acrylic case, to enhance the novelty by displaying the construction inside and the electronic circuitry, as well as the cathode ray tube.

This is offered in conjunction with application for patent, and claims priority of provisional patent application No. 61/203,774

The Oscilloscope Clock displays time on a cathode ray tube, like those used in oscilloscopes. It is displayed in a clear acrylic case, showing all the electronic components inside. It has two buttons to set time with, a fast set and a slow set. It displays a classic analog clock face, which is ‘drawn’ on the face of the crt by manipulating the electron beam, exactly as done in an oscilloscope.

It is a surprisingly simple construction, as I have tried to keep it as uncomplicated as possible. The high voltage to drive the crt is supplied from a simple ‘voltage multiplier’, which uses the classic method of cascading voltage from one capacitor to another, by directing the positive polarity of AC voltage through a diode to the next stage, thus adding to the voltage from the previous stage. By doubling the voltage in this manner from standard U.S AC 120V, a positive potential of about 300V DC is achieved, then by also doubling the voltage in the negative potential, −300V is achieved, totaling about 600V DC or so, enough to drive many standard crt's. The grid or brightness control of the crt is tied to the most negative voltage of the supply. The Cathode of the crt is tied to the wiper of a 50,000 ohm potentiometer, with it's fixed terminals tied to the lowest voltage of the supply and a 470,000 ohm resistor, the other terminal of which is tied to a point of the supply in between the two negative stages, at about 150V or so, this is easy to understand if viewed on the schematic diagram supplied with this application. A 1,000,000 ohm potentiometer tied to 0V and −300V on it's fixed terminals supplies the focusing anode of the crt through it's wiper, enabling focusing of the display. In the same manner, a 1,000,000 ohm potentiometer tied to the 0V and 300V nodes of the high voltage supply adjusts the astigmatism of the final anode, through it's wiper terminal. The 120V AC is also supplied to a 120V primary/dual secondary 8V/8V transformer. One secondary supplies the filament current to the crt through a series resistor, which is adjusted to suit the crt's filament resistance when hot, so that it draws approximately 400 ma current. The other secondary, which is a completely separate winding from the first, supplies the low voltage through a 5V regulator, being first rectified by a full wave bridge of rectifier diodes, then smoothed or filtered by a capacitor, and finally regulated at 5V to supply low voltage digital integrated circuits, which manipulate the crt's beam through deflection amplifiers, like those used in an oscilloscope. The 60 HZ frequency supplied in all electric service in the U.S (or 50 HZ in some other countries) is shaped into a square digital waveform by the series resistor and capacitor tied to the transformer secondary that supplies the low voltage (5V) and the NPN transistor that the signal is sent through to the microcontroller that provides outputs to a digital to analog converter which drives the deflection amps. The deflection amps in this circuit are high voltage (500V) NPN transistors. Ground or 0V of the low voltage supply is tied to 0V of the high voltage supply, so the deflection amps' transistors are tied to the 300V of the HV supply through 330,000 ohm resistors on the collectors, and to the 0V through 4,700 ohm resistors on the emmiters. The base of each transistor of each deflection amp is biased between 0v and 5V, and the bias of one side of each pair is controlled by a 50,000 ohm potentiometer, to enable adjustment of the centering. Each pair of deflection amps is tied to a set of plates or deflection anodes in the crt, in order to electrostatically control the crt's electron beam, as is done in an oscilloscope. The bias of the other side of each pair is controlled by the digital to analog converter IC, and the bias on these is also controlled by a ‘shifter ’ circuit, which moves the display slightly every minute or so to prevent burn in of the crt's phosphor screen. This is accomplished by using a small microcontroller running a simple loop program to adjust a digital potentiometer every minute, which has it's wiper tied to the base of the deflection transistor. The blanking circuit is a NPN/PNP pair which is tied to the focus anode through the collector of the NPN, and the −140V through the same transistor's emitter, thus the digital signal from the microcontroller determines when the display is blanked (in between strokes).

The circuit board portion is constructed on perforated board, commonly used for experimenting & prototyping electronic circuits, and wired point to point, soldering to each point, or on homemade printed circuit board, and sockets are used so the ICs can be replaced easily. This is bolted to an acrylic base using standard ¼″×3″ bolts, and using a nut on either side of the board to stand it off 1″ above the base. The transformer is also bolted to the base in like manner. The crt is held in place with a 1″ conduit clamp, bolted to a piece of all thread which is bolted to the base and adjusted to height of about 5″ above the base. A fuse is bolted to the base and is in series with the 120V AC. The electric cord with plug is threaded through a hole in the base and clamped in place with a zip tie. A thermoformed acrylic shroud covers the entire assembly and rests on top of the base.

The Oscilloscope Clock can be viewed in operation at the youtube site:

http://www.youtube.com/watch?v=NHtHLGlgKlA

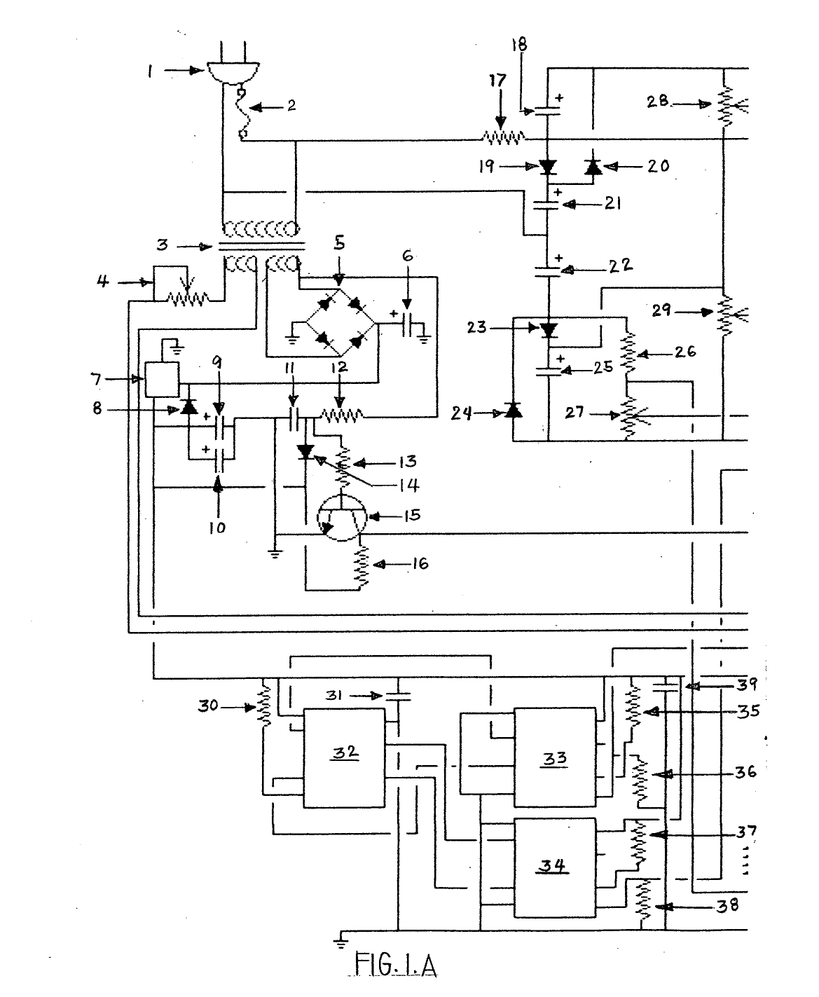

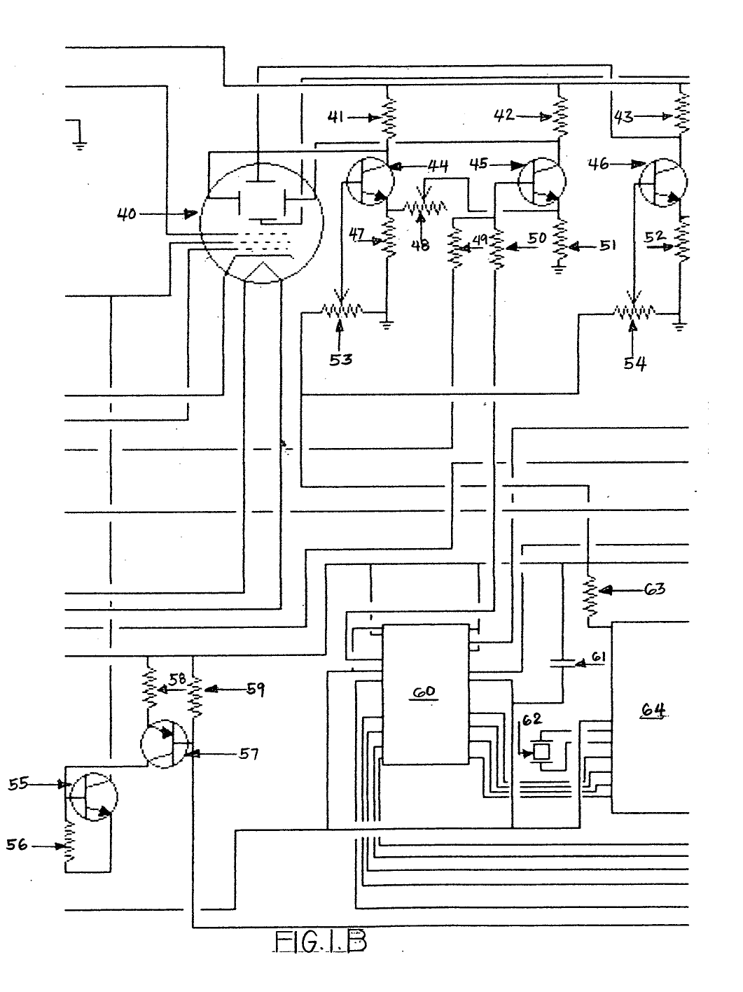

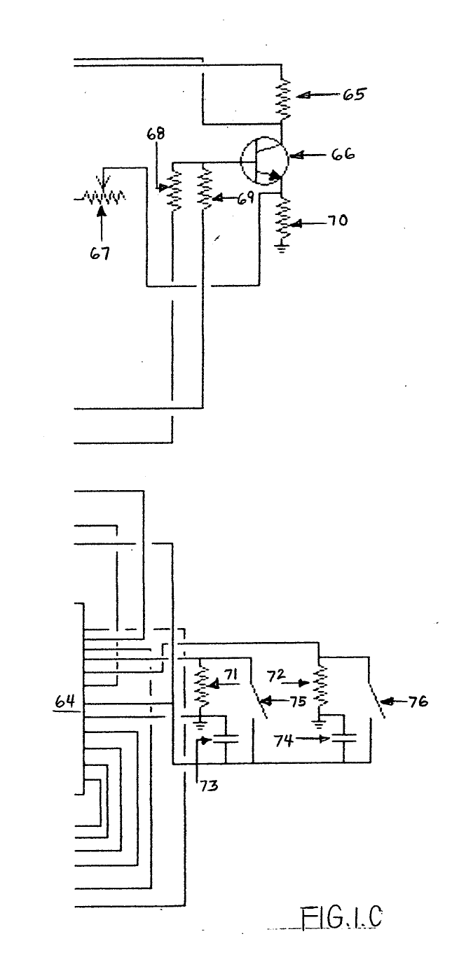

FIG. 1A is a partial view of the oscilloscope clock schematic drawing showing the line voltage input (ac power cord), low voltage power supply circuitry, wave shaping circuitry, high voltage power supply circuitry, and a portion of the digital logic circuitry used to manipulate the crt's electron beam.

In reference to FIG. 1A, the numbered components are:
1. An AC power cord, for use with standard Electric outlet, 120 VAC.
2. A 1 amp, 250 V inline fuse
3. A power transformer with primary of 120 VAC and dual secondaries of 8 VAC each.
4. A 25 ohm, 5 watt potentiometer
5. A 5 watt full wave rectifier bridge
6. A 1,000 microfarad, 16 volt capacitor
7. A 5 volt regulator integrated circuit, 7805
8. A 50 volt rectifier diode, 1N4001
9. A 100 microfarad, 10 volt capacitor
10. A 0.1 microfarad, 10 volt capacitor
11. A 0.01 microfarad, 10 volt capacitor
12. A 100,000 ohm, ½ watt resistor
13. A 10,000 ohm, ½ watt resistor
14. A 50 volt rectifier diode, 1N4001
15. An NPN small signal transistor, 2N3904
16. A 1,000 ohm, ½ watt resistor
17. A 10 ohm, 1 watt metal film resistor
18. A 4.7 microfarad, 450 volt electrolytic capacitor
19. A 1,000 volt rectifier diode, 1N4007
20. A 1,000 volt rectifier diode, 1N4007
21. A 4.7 microfarad, 250 volt electrolytic capacitor
22. A 4.7 microfarad, 250 volt electrolytic capacitor
23. A 1,000 volt rectifier diode, 1N4007
24. A 1,000 volt rectifier diode, 1N4007
25. A 4.7 microfarad, 450 volt electrolytic capacitor
26. A 470,000 ohm, ½ watt resistor
27. A 50,000 ohm, ½ watt potentiometer
28. A 1,000,000 ohm ½ watt potentiometer
29. A 1,000,000 ohm ½ watt potentiometer
30. A 2,200 ohm ½ watt resistor
31. A 0.1 microfarad, 10 volt capacitor
32. A preprogrammed 12F629 PIC microcontroller integrated circuit
33. A 4132 digital rheostat integrated circuit
34. A 4132 digital rheostat integrated circuit
35. A 47,000 ohm, ½ watt resistor
36. A 47,000 ohm, ½ watt resistor
37. A 47,000 ohm, ½ watt resistor
38. A 47,000 ohm, ½ watt resistor
39. A 0.1 microfarad, 10 volt capacitor

FIG. 1B is a partial view of the oscilloscope clock schematic drawing showing the electron beam blanking circuitry, a portion of the digital logic circuitry used to manipulate the electron beam, a portion of the

circuitry used to interface the low voltage digital logic circuitry to the high voltage required by the crt, and a representation of the crt.

The following numbered components are found on FIG. 1B:
40. A DG7-32 Cathode ray tube, or similar
41. A 330,000 ohm, ½ watt resistor
42. A 330,000 ohm, ½ watt resistor
43. A 220,000 ohm, ½ watt resistor
44. A 500 volt NPN transistor, Mpsa44
45. A 500 volt NPN transistor, Mpsa44
46. A 500 volt NPN transistor, Mpsa44
47. A 4,700 ohm, ½ watt resistor
48. A 50,000 ohm, ½ watt potentiometer
49. A 10,000 ohm, ½ watt resistor
50. A 10,000 ohm, ½ watt resistor
51. A 4,700 ohm, ½ watt resistor
52. A 4,700 ohm, ½ watt resistor
53. A 50,000 ohm, ½ watt potentiometer
54. A 50,000 ohm, ½ watt potentiometer
55. A 500 volt NPN transistor, Mpsa44
56. A 10,000 ohm, ½ watt resistor
57. A 300 volt PNP transistor, Mpsa92
58. A 47,000 ohm, ½ watt resistor
59. A 10,000 ohm, ½ watt resistor
60. A TLC7528 digital to analog converter integrated circuit
61. A 0.1 microfarad, 10 volt capacitor
62. A 20 MHZ crystal
63. A 2,200 ohm, ½ watt resistor
64. A PIC18F2610 microcontroller integrated circuit, preprogrammed

FIG. 1C is a partial view of the oscilloscope clock schematic drawing showing the remaining portion of the circuitry used to interface the digital logic circuitry to the high voltage (deflection amplifiers), and the remaining portion of the digital logic circuitry.

The following numbered components are found on FIG. 1C:
65. A 220,000 ohm, ½ watt resistor
66. A 500 volt NPN transistor, Mpsa44
67. A 50,000 ohm, ½ watt potentiometer
68. A 10,000 ohm, ½ watt resistor
69. A 10,000 ohm, ½ watt resistor
70. A 4,700 ohm, ½ watt resistor
71. A 2,200 ohm, ½ watt resistor
72. A 2,200 ohm, ½ watt resistor
73. A 0.1 microfarad, 10 volt capacitor
74. A 0.1 microfarad, 10 volt capacitor
75. A small normally open pushbutton switch
76. A small normally open pushbutton switch

1. My claim is that I have developed and invented this particular use of a cathode ray tube and microcontroller myself, the circuitry is my original design, and I wrote the program that is downloaded to a blank microcontroller to complete the operation of the construction, intended to be a novelty clock.
